(19) United States
(12) Patent Application Publication
(10) Pub. No.: US 2025/0247517 A1
(43) Pub. Date: Jul. 31, 2025

(54) RAPID USER INPUT DETERMINATION SYSTEM AND METHOD FOR USING THE SAME

(71) Applicant: JORJIN TECHNOLOGIES INC., New Taipei City (TW)

(72) Inventors: Wei En HSU, New Taipei City (TW); Kuan Chun CHEN, New Taipei City (TW)

(21) Appl. No.: 19/037,140

(22) Filed: Jan. 25, 2025

(30) Foreign Application Priority Data
Jan. 25, 2024 (TW) 113102929

(51) Int. Cl. H04N 13/398; G06F 3/01; H04N 13/178; H04N 13/327; H04N 13/361; H04N 13/383

(52) U.S. Cl. CPC H04N 13/398; G06F 3/013; G06F 3/017; H04N 13/178; H04N 13/327; H04N 13/383; H04N 13/361

(57) ABSTRACT

A rapid user input determination system includes a control device, a head-mounted device signal connected to the control device, and a motion sensing device. The control device is configured to receive and store a command as a user input to the head-mounted device or the motion sensing device, and to output a corresponding content to the head-mounted device or the motion sensing device. The control device combines a visual focus of the user detected by the head-mounted device with a triggering action or a triggering posture as the command, and the triggering action and the triggering posture are performed by the user and detected by the motion sensing device. When the control device receives the command, the control device interacts with or operates at least one Internet of Things (IoT) device, or adjusts a content presented on the head-mounted device according the command.

### FIELD OF INVENTION

The disclosure is related to a user input determination system, especially to a rapid user input determination system and method for using the same.

### BACKGROUND OF THE INVENTION

Application of virtual reality (VR) and augmented reality (AR) technologies is rapidly expanding to bring significant changes across various fields. For example, in the field of entertainment, VR and AR are used in immersive gaming, virtual tourism, and virtual reality videos to provide users with engaging and immersive experiences. Additionally, VR and AR have broad applications in other fields. In the field of education, students can gain more specific learning experiences, such as simulating scientific experiments or historical scenarios through VR to enhance knowledge comprehension and retention. In the medical field, AR can be applied in surgical navigation and training to improve surgical precision and to enhance professional medical skills. Furthermore, enterprises can introduce VR and AR technologies for training, maintenance and design purposes to increase working efficiency and to reduce costs.

However, current VR and AR technologies still face challenges in recognizing user inputs. For example, many current VR or AR systems rely on users' eye gazes or blinks to confirm user inputs. These confirm methods not only respond too slowly but also lack intuitiveness to lead user frustration during interactions and user experience is affected. Additionally, steep learning curves of the conventional VR or AR systems require users to spend extra time adapting to the operation methods, thereby convenience of user experience is diminished. Furthermore, when the conventional VR or AR systems experience delays or fail to recognize and respond to users' commands in real-time, latency caused by the systems disrupts the seamlessness and fluidity between the virtual or augmented reality and the real world.

In view of the above challenges, improving system recognition speed and intuitiveness of AR or VR system has become an urgent development objective in the relevant field.

### SUMMARY OF THE INVENTION

Therefore, in order to enhance the system recognition speed and intuitiveness for VR and AR, an object of the present invention is to provide a rapid user input determination system and a method for using the same to resolve the problem previously mentioned.

According to the present invention, the rapid user input determination system includes a control device, a head-mounted device and a motion sensing device. The head-mounted device and the motion sensing device are signal connected to the control device. The control device is configured to receive a command from the head-mounted device and the motion sensing device as a user input and to output a corresponding content based on the command back to the head-mounted device and the motion sensing device.

The head-mounted device includes at least one display and at least one eye-tracking unit. The display is configured to demonstrate a display content and to update the display content based on the corresponding content received from the control device. The eye-tracking unit is configured to track a movement and a motion trajectory of at least one of the user's eyes to determine a visual focus of the user on the display content. The motion sensing device is configured to detect a motion or a posture of the user's hand and transmit a hand-gesture information serving as the command to the control device, wherein the motion and the posture are respectively defined as a triggering action and a triggering posture. The control device combines the visual focus of the user with the triggering action or the triggering posture of the user as the command.

The head-mounted device further includes at least one camera and at least one inertial measurement unit. The camera is configured to detect an external environment of the head-mounted device to collect multiple images or multiple video records in real time, and transmit the images or video records to the control device. The inertial measurement unit is configured to detect a movement of the user's head, and a position of the display content demonstrated on the display can be adjusted based on a detecting result of the inertial measurement unit.

At least a portion of the motion sensing device is embedded in or detachably mounted on the head-mounted device, the control device is further configured to store and output the command to at least one Internet of Things (IoT) device after the control device receives the command from the head-mounted device or the motion sensing device.

The motion sensing device includes a depth camera, a radar, or a wristband.

The camera is configured to provide real-time images and to transmit the real-time images to the control device.

According to the present invention, the method of rapid user input determination is in operation by using the rapid user input determination system. The method of rapid user input determination involves following steps:

Demonstrating a display content on a head-mounted device; determining a target selected by a user with the eye-tracking unit; detecting a triggering action or a triggering posture with the motion sensing device to confirm the target selected by the user; and executing the command corresponding to the target and updating the display content.

The display content includes a user interface, a virtual reality image or an augmented reality image. The user interface has multiple selection boxes for the user to select from. The virtual reality image or the augmented reality image has an auxiliary image corresponding to at least one Internet of Things (IoT) device.

The display content dynamically displays a position of the user's visual focus on the display in real time and a content shown at the position overlays other contents of the display content.

When the user's visual focus is located on one of the selection boxes or the auxiliary images, a display state of the selection box or the auxiliary image changes, and a change of the display state involves color changes or blinking.

As described above, the present invention has following features:
1. By tracking the movement and the motion trajectory of the user's eyes to determine the visual focus, and detecting the motion or the posture of the user's hand to confirm the command in coordination, the rapid user input determination system enables precise and real-time execution for the command as the user inputs, thereby input latency is significantly reduced compared to a conventional head-mounted device to provide the user with smoother and more seamless experiences.
2. The user's input command can be confirmed based on the detection of the motion or the posture of the user's hand and the visual focus by detecting the movement and the motion trajectory of the user's eyes, rather than relying on eye gazing or blinking to confirm input commands as in the case of the convention head-mounted devices. The rapid user input determination system enhances flexibility of the user experience, and reduces the time required for learning and adapting to the system to lower the learning curve thereof. Additionally, the invention is configured to prevent interference with the user's visual experience during the input process.

### BRIEF DESCRIPTION OF THE DRAWINGS

FIG. 1 is a block diagram of a preferred embodiment of a structural arrangement in a rapid user input determination system according to the present invention;

FIG. 2 is a block diagram of another preferred embodiment of structural arrangement of a rapid user input determination system according to the present invention;

FIG. 3 is a perspective view illustrating a preferred embodiment of a head-mounted device of the rapid user input determination system shown in FIG. 1;

FIG. 4 is a front view illustrating the head-mounted device in FIG. 3;

FIG. 5 is a rear view illustrating a head-mounted device in FIG. 3;

FIG. 6 is an operational perspective view illustrating a preferred embodiment of a motion sensing device of the rapid user input determination system shown in FIG. 1;

FIG. 7 is a block diagram of a preferred embodiment of a method of rapid user input determination according to the present invention;

FIGS. 8A and 8B illustrate operational schematic diagrams of a display content of the head-mounted device of the rapid user input determination system shown in FIG. 1; and

FIGS. 9 and 10 illustrate operation schematic diagrams showing a relation between a user input command and the display content of the rapid user input determination system.

### DETAILED DESCRIPTION OF THE PREFERRED EMBODIMENTS

The present invention employs block diagrams to illustrate the operations performed by the system according to embodiments of the invention. It should be understood that the preceding or subsequent operations are not required to be executed in an exact sequence. Instead, the steps may be performed in reverse order or processed concurrently. Additionally, other operations may be added to these processes, or certain steps may be removed from these processes

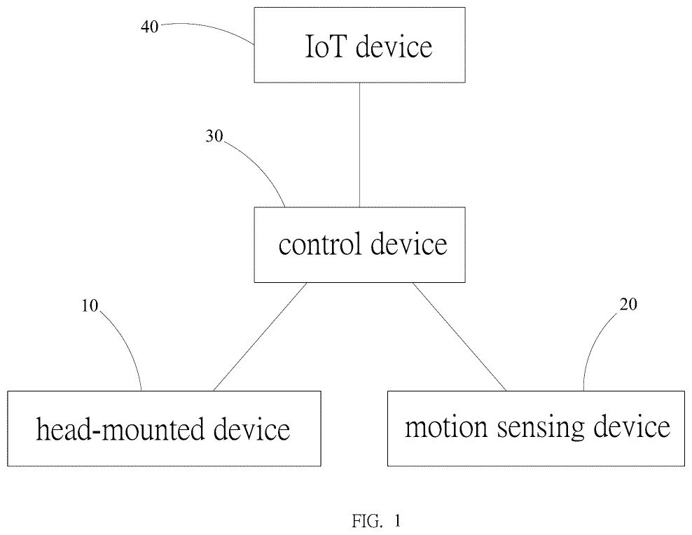

Referring to FIG. 1, a preferred embodiment of a rapid user input determination system is disclosed. The rapid user input determination system includes a control device 30, a head-mounted device 10 and a motion sensing device 20. The head-mounted device 10 and the motion sensing device 20 are signal-connected to the control device 30 respectively. The control device 30 may be signal-connected to the head-mounted device 10 and the motion sensing device 20 wirelessly or via one or more electrical transmission line alternatively. The control device 30 is configured to receive and store a command input by a user input via the head-mounted device 10 and/or the motion sensing device 20, and to output a corresponding content based on the command to an Internet of Things (IoT) device 40 and/or the head-mounted device 10.

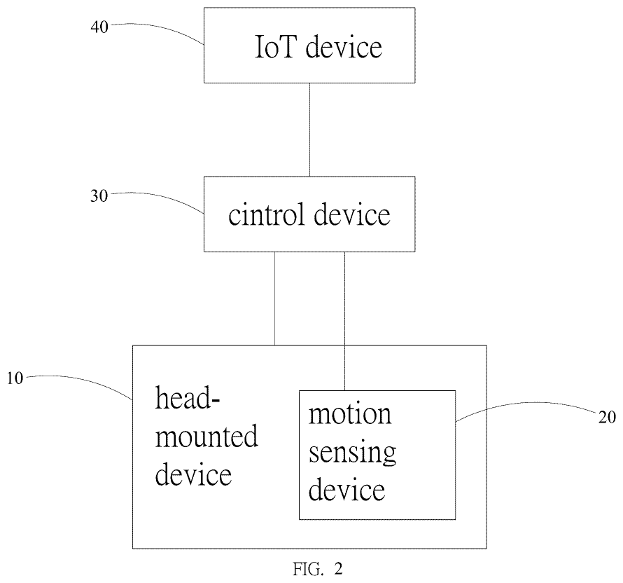

Referring to FIG. 2, in another preferred embodiment, the motion sensing device 20 may be partially or entirely embedded in, or detachably mounted to the head-mounted device 10. Upon receiving the command transmitted from the head-mounted device 10 and the motion sensing device 20, the control device 30 outputs the command to the IoT device 40 and transmits the corresponding content back to the head-mounted device 10 and the motion sensing device 20.

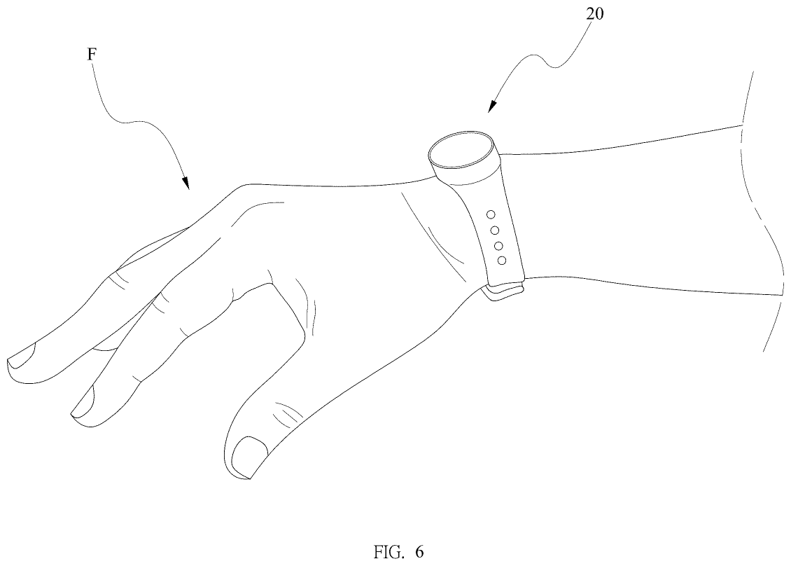

Referring to FIGS. 6 to 10, the IoT device 40 may include various network-connected devices being capable of performing actions according to the command receiving via wireless signal. The IoT device 40 may include various smart home appliances, such as a television, a speaker, a lighting fixture, an air conditioner, and another.

In some preferred embodiments, the control device 30 is a mobile device, such as a smartphone, a tablet, or a laptop computer.

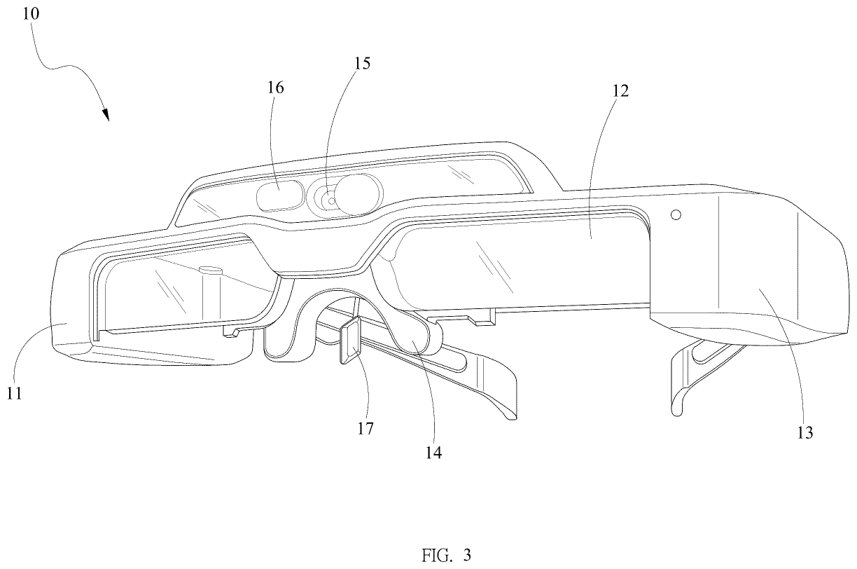

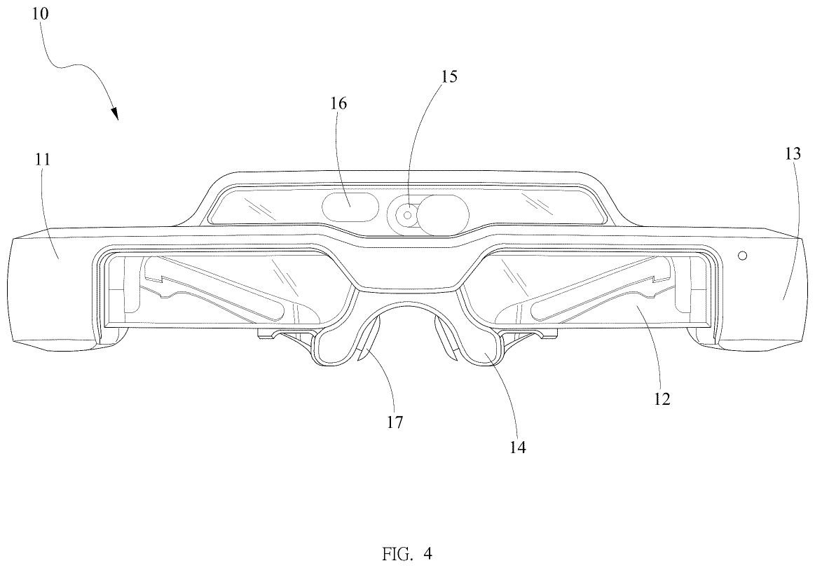

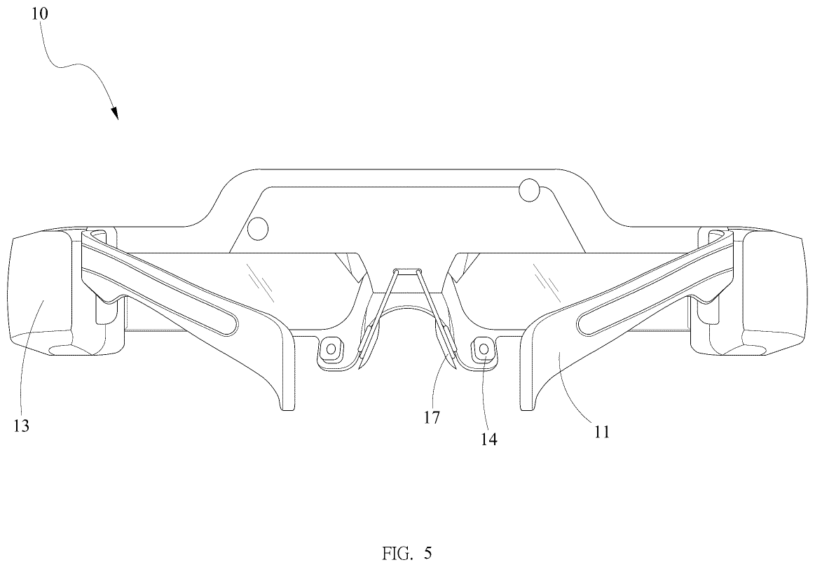

The head-mounted device 10 may take various forms. Referring to FIGS. 3 to 5, in this preferred embodiment, the head-mounted device 10 is a smart glasses device but is not limited to this form. The head-mounted device 10 includes a frame 11, at least one display 12, at least one inertial measurement unit (IMU) 13, at least one eye-tracking unit 14, and at least one camera 15.

The frame 11 is configured to secure the head-mounted device 10 to the user's head and to stabilize various components of the head-mounted device 10.

The at least one display 12 is configured to demonstrate a display content 121 and to update the display content 121 based on the corresponding content received from the control device 30. Each display 12 may be a transparent or non-transparent display.

Preferably, the head-mounted device 10 includes two displays 12. When the user wears the head-mounted device 10, the two displays 12 are positioned respectively in front of the user's eyes, and the two displays 12 may display identical or different display content 121, or only one of the two displays 12 may display the display content 121. In the preferred embodiment, the two displays 12 are transparent displays and allow the user to see the scene of an external environment through the displays 121 while the display content 121 is simultaneously shown on the displays 12. Preferably, the display content 121 can interact with an image of the external environment. For example, a part of the display content 121 may correspond to edges or contours of the image of the external environment, or the part of the display content 121 may track a moving object displayed in the image. Additionally, the display content 121 may also serve as a user interface 122 including multiple selection boxes to allow the user to input the command by selecting the selection boxes.

The IMU 13 is configured to detect a movement of the user's head, and a position of the display content 121 demonstrated on the displays 12 or a display mode of the display content 121 shown on the displays 12 can be adjusted based on a detecting result of the IMU 13 to facilitate an interaction between the display content 121 and the external environment.

The eye-tracking unit 14 is positioned adjacent to the displays 12. Preferably, the eye-tracking unit 14 is located below the displays 12. The eye-tracking unit 14 is configured to track a movement of the user's eyes including horizontal and vertical motions and a motion trajectory of the eyes to trace a visual focus of the user. The visual focus represents an area of the display 12 which the user is gazing at, and may be serves as a portion of the display content 121.

Specifically, in the preferred embodiment, the eye-tracking unit 14 is configured to emit an infrared light toward the user's eyes, then to receive the reflected infrared light from the eyes based on a reflective property of the pupils and corneas, and to analyze changes in the reflected infrared light to calculate the movement and the motion trajectory of the eyes.

The camera 15 is configured to detect changes in the external environment of the head-mounted device 10 and to collect multiple images or multiple video records. The images or video records are stored or transmitted to the control device 30 and displayed synchronically on the head-mounted device 10. The display content 121 can be adjusted in the display mode and interact with the image of the external environment based on output from the camera 15 in collaboration with the IMU 13. Preferably, the camera 15 is positioned on the frame 11 and above the displays 12. In the preferred embodiment, the camera 15 provides the images to the control device 30 in real time. For example, the camera 15 may transmit real-time images to a remote expert via the control device 30 to allow the expert to understand the user's view and provide guidance.

Preferably, the head-mounted device 10 further includes a depth sensing unit 16. The depth sensing unit 16 is configured to measure a distance between the user and a target object in the images or two independent target objects, and to provide a depth information for the images. The depth sensing unit 16 may employ various technologies, such as a stereo vision technology using two or more cameras to detect depth, a structured light technology projecting a directional light source and receiving reflected diffuse patterns, a time-of-flight (ToF) technology measuring distances based on the time delay between emitted and returned signals, or a radar technology measuring distances using emitted and returned signals.

Referring to FIG. 6, in this embodiment, the motion sensing device 20 may be a wristband worn or attached to the user's hand F and is configured to detect a motion or a posture of the user's hand F, to record and to transmit a hand-gesture information serving as the command to the control device 30.

The hand F may refer to the user's arm, palm, or multiple fingers. The motion or the posture of the hand F are respectively defined as a triggering action and a triggering posture. When the user performs the triggering action or the triggering posture, the control device 30 determines the area of the visual focus as the command executed. Preferably, the motion sensing device 20 may work in collaboration with the camera 15 and/or the depth sensing unit 16 to detect the user's action, posture, or gesture to confirm the execution of the triggering action or the triggering posture for the command input.

In the preferred embodiment, when the user's hand F enters the detection range of the camera 15 and/or the depth sensing unit 16, the camera 15 and/or the depth sensing unit 16 work in collaboration with the motion sensing device 20 to ensure whether the hand F has performed the triggering action or the triggering posture.

In another embodiment, the motion sensing device 20 collaborates with the camera 15 and the depth sensing unit 16 to detect the user's action or posture. When the user performs the triggering action or the triggering posture, the control device 30 determines the area of the visual focus as the command executed.

In another embodiment, the motion sensing device 20 may serve as, but is not limited to, a radar or a depth camera.

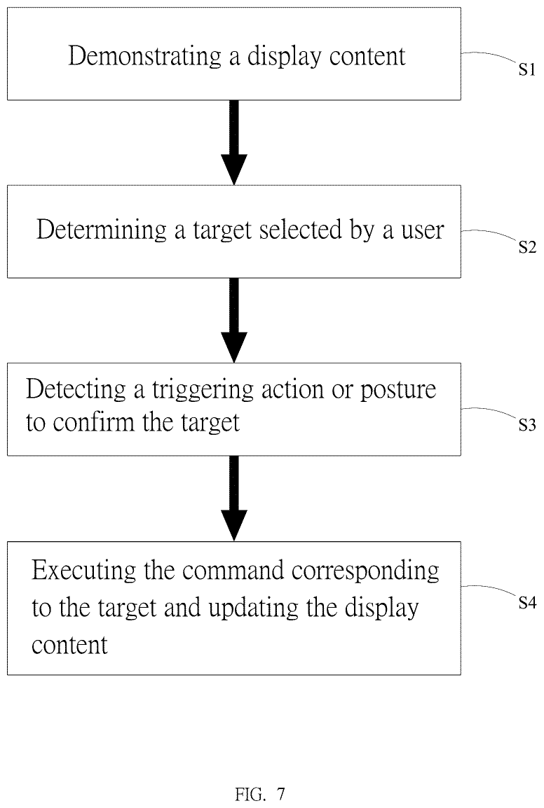

Referring to FIG. 7, a preferred embodiment of a method of rapid user input determination is disclosed. The method of rapid user input determination is executed by the rapid user input determination system and includes the following steps:

Step S1: Demonstrating the display content 121.

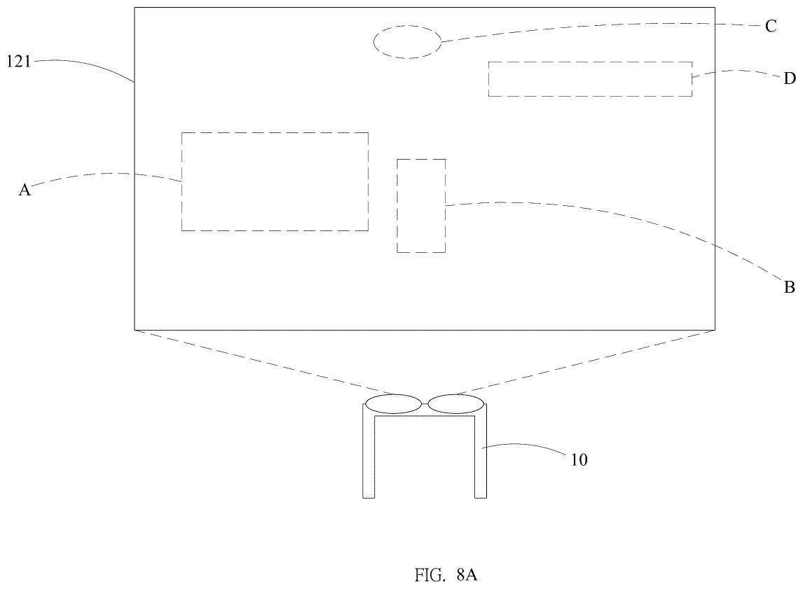

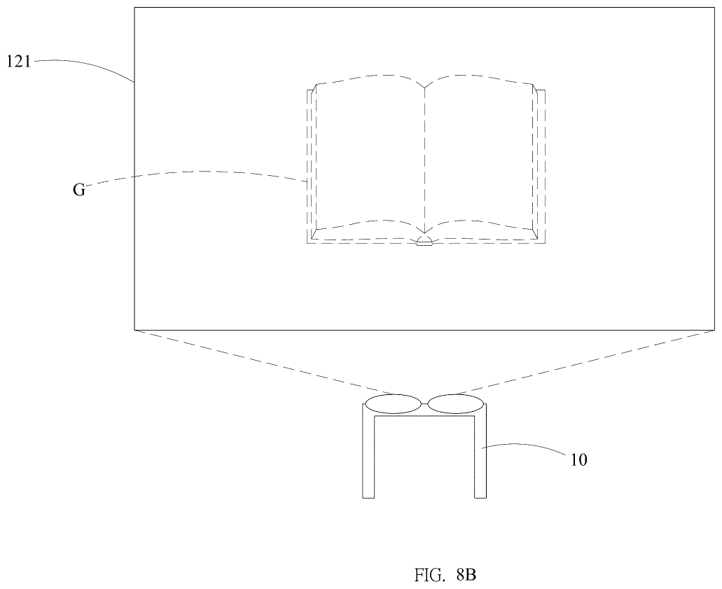

Referring to FIGS. 8 to 10, in the step S1, the display content 121 is demonstrated on the display 12 of the head-mounted device 10. The display content 121 serve as a user interface 122 including multiple selection boxes for the user to select, an image of the external environment, or a moving object displayed in the image. A part of the display content 121 displayed on the display 12 corresponds to edges or contours of the image or is applied to track the moving object. The user interface 122 may also include multiple symbols, multiple text strings, or at least one button.

The display content 121 may further include a virtual reality (VR) image or an augmented reality (AR) image, and the VR image or the AR image includes an auxiliary image corresponding to the IoT device and being configured to indicate a position of the IoT device in the display content 121.

Referring to FIG. 8A, in one embodiment, the display content 121 demonstrates multiple IoT devices positioned in the external environment and located within a range of the display content 121, such as a television A, a speaker B, a lighting fixture C, and an air condition D.

In another embodiment, referring to FIG. 8B, the display content 121 demonstrates a virtual image input by the control device 30. The virtual image may be a virtual book G showing multiple text strings to provide application contents to the user.

Step S2: Determining a target selected by the user with the eye-tracking unit 14.

Referring to FIGS. 3, 7 and 9, in step S2, the eye-tracking unit 14 is configured to track the movement and the motion trajectory of the user's eyes E to ensure the user's visual focus.

Preferably, the display content 121 dynamically displays a position of the visual focus on the display 12 in real time, and a content shown at the position overlays other contents of the display content 121 to allows the user to easily identify and correct the visual focus.

Preferably, when the visual focus is located on one of the selection boxes or the auxiliary image corresponding to the IoT device, a display state of the selection box or the auxiliary image changes to allow the user to easily recognize that the visual focus has entered the area of the selection box or the auxiliary image, such that the area becomes a potential target. In the preferred embodiment, a change of the display state of the selection box or the auxiliary image includes color change. In another embodiment, the change of the display state involves blinking.

In some preferred embodiments, the user can trigger to open or select the target by performing different actions or postures through detection by the motion sensing device 20. Thus, the target is demonstrated in the display content 121 of the display 12. For example, in one embodiment, the user can open the button shown in the display content 12 by performing an open-hand action and further select the target using the movement and the motion trajectory of the user's eyes E.

Step S3: Detecting the triggering action or the triggering posture with the motion sensing device to confirm the target selected by the user. In step S3, when the user performs the triggering action or the triggering posture, the motion sensing device 20 is configured to recognize the user's triggering posture and/or the triggering action to confirm the target selected by the user.

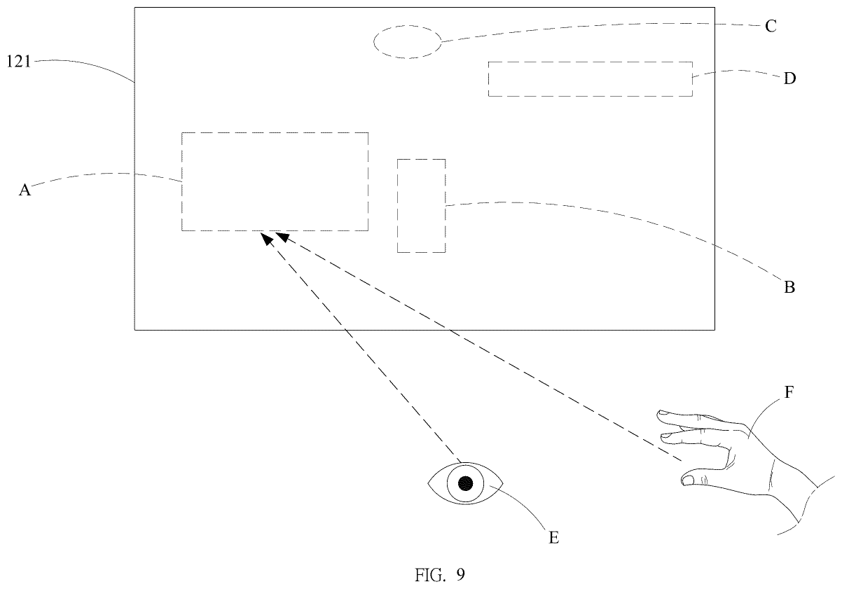

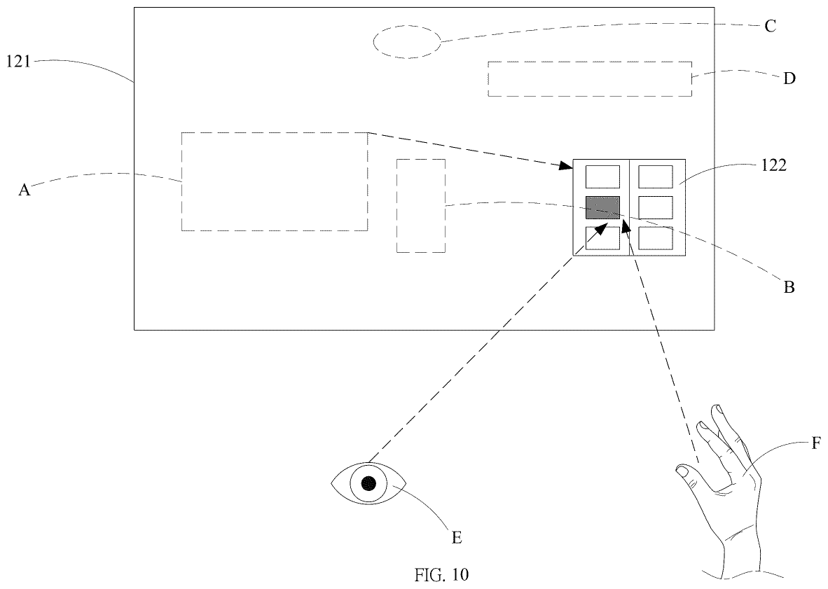

In the preferred embodiment, when the visual focus falls within the area of the selection box, an execution of the selected target is identified by detecting the user's triggering action or the triggering posture. In the preferred embodiment, as shown in FIGS. 9 and 10, for example, when the visual focus of the user's eyes E falls within the auxiliary image corresponding to the television A, the triggering action or the triggering posture of the user's hand F is performed to open the selected selection box serving as a settings menu for the television A.

In another preferred embodiment, referring to FIG. 8B, when the visual focus of the user's eyes E falls on the VR image shown in the display content 121, such as a virtual book G, the selected selection box serving as the setting menu for the virtual book G enables to open via performing the triggering action or the triggering posture of the user's hand F.

Step S4: Executing the command corresponding to the target to update the display content 121. Referring to FIGS. 7 and 9, in step S4, after the user completes the command input and the selection of the target, the control device 30 receives the command and outputs the corresponding content to the head-mounted device 10, and then the display content 121 displaying on the display 12 would update based on the corresponding content.

Subsequently, Steps S1 to S4 can be executed repeatedly.

Based on above descriptions, the present invention achieves the following effects.
The rapid user input determination system can identify the selected area through the movement and motion trajectory of the user's eyes, and confirm the command input by the user with the motion and posture collaboratively, thereby the command can be executed precisely in real time and the input latency is reduced to provide a smoother user experience.
2. The rapid user input determination system can identify the selected area through the movement and motion trajectory of the user's eyes, and simultaneously confirm the command input by the user with the motion and posture, rather than ensuring the command via eyes gazing or blinks as the conventional head-mounted device, thereby the flexibility of the user experience is reduced, and the required time for learning and adapting to the system is decreased to lower the learning curve. Additionally, the interference with visual experience during command input can be avoided.

1. A rapid user input determination system comprising:
a control device;
a head-mounted device signal-connected to the control device and comprising at least one display and at least one eye-tracking unit; and
a motion sensing device; wherein,
the control device is configured to receive a command as a user input and to output a corresponding content based on the command to the head-mounted device and the motion sensing device;
the at least one display is configured to demonstrate a display content and to update the display content based on the corresponding content received from the control device,
the eye-tracking unit is configured to track a movement and a motion trajectory of at least one of the user's eyes to determine a visual focus of the user on the display content,
the motion sensing device is configured to detect a motion or a posture of the user's hand and to transmit a hand-gesture information serving as the command to the control device, wherein the motion and the posture are respectively defined as a triggering action and a triggering posture,
the control device combines the visual focus of the user with the triggering action or the triggering posture of the user as the command.

2. The rapid user input determination system as claimed in claim 1, wherein the head-mounted device further comprises at least one camera and at least one inertial measurement unit, the at least one camera is configured to detect an external environment of the head-mounted device to collect multiple images or multiple video records in real time, and to transmit the images or video records to the control device, the at least one inertial measurement unit is configured to detect a movement of the user's head, and a position of the display content demonstrated on the at least one display can be adjusted based on a detecting result of the inertial measurement unit.

3. The rapid user input determination system as claimed in claim 2, wherein at least a portion of the motion sensing device is embedded in or detachably mounted on the head-mounted device, the control device is further configured to store and to output the command to at least one Internet of Things (IoT) device after the control device receives the command as the user input to the head-mounted device or the motion sensing device.

4. The rapid user input determination system as claimed in claim 1, wherein the motion sensing device comprises a depth camera, a radar, or a wristband.

5. The rapid user input determination system as claimed in claim 2, wherein the motion sensing device comprises a depth camera, a radar, or a wristband.

6. The rapid user input determination system as claimed in claim 3, wherein the motion sensing device comprises a depth camera, a radar, or a wristband.

7. A method of using the rapid user input determination system as claimed in claim 1 and comprising following steps:
demonstrating a display content on a head-mounted device;
determining a target selected by a user with the eye-tracking unit; and
detecting a triggering action or a triggering posture with the motion sensing device to confirm the target selected by the user.

8. The method as claimed in claim 7, wherein a part of the display content interacts with an image of an external environment, the part of the display content corresponds to edges or contours of the image, or tracks a moving object displayed in the image.

9. The method as claimed in claim 7, wherein the display content comprises a user interface, a virtual reality image or an augmented reality image; wherein,
the user interface includes multiple selection boxes, multiple symbols, selection boxes text strings or at least one button; and
the virtual reality image or the augmented reality image includes an auxiliary image corresponding to at least one Internet of Things (IoT) device.

10. The method as claimed in claim 9, wherein the display content dynamically displays a position of the user's visual focus on the display in real time and a content shown at the position overlays other contents of the display content.

11. The method as claimed in claim 9, wherein,
when the user's visual focus is located on one of the selection boxes or the auxiliary images, a display state of the selection box or the auxiliary image changes, and a change of the display state involves color changes or blinking.
